(19) United States
(12) Patent Application Publication
(10) Pub. No.: US 2007/0243983 A1
(43) Pub. Date: Oct. 18, 2007

(54) Roller assembly for use in conveying heavy loads

(75) Inventor: Matthew Wendell Schroeder, Ventura, IA (US)

Correspondence Address: G. BRIAN PINGEL, BROWN, WINICK, GRAVES,;GROSS, BASKERVILLE AND SCHOENEBAUM, P.L.C., REGENCY WEST 5, 4500 WESTOWN PARKWAY, SUITE 277, WEST DES MOINES, IA, 50266, US

(73) Assignee: Stellar Industries, Inc.

(21) Appl. No.: 11/403,369

(22) Filed: Apr. 13, 2006

(51) Int. Cl. F16C 13/00

(52) U.S. Cl. 492/16

(57) ABSTRACT

A new roller assembly for use in heavy duty applications such as hooklift trucks and conveyors in mining operations is based on a nonmetallic roller having high tensile strength around 12000 psi, high compressive strength in the neighborhood of 15000 psi, a modulus of elasticity about 400 ksi, and operating temperature range of about −30F to 200F. The new roller assembly includes no bushing and requires no lubrication so no grease zerk is necessary. It provides a longer life, and requires less materials and machining costs.

### FIELD OF INVENTION

This invention pertains generally to conveyance rollers, specifically those used to convey heavy containers or upon which conveyor belts roll in heavy duty applications.

### BACKGROUND

Heavy duty rollers employed to assist in conveying heavy objects or in industrial conveyors used in such industries as mining have traditionally been crafted from steel. The operation of these rollers requires bushings in order for the rollers to turn under heavy loads. In turn, the bushings require lubrication between the roller and the pin, so these rollers are equipped with grease zerks or other ports so that lubricating materials can be periodically introduced to the bushing. Without lubrication, the rollers can stop turning.

Steel rollers are often painted for aesthetic purposes. However, the paint soon wears off in the conditions under which most such rollers are employed which include large swings in temperature. Dirt and other contaminants on the roller that run between the roller and the load also attribute to the wearing of the paint. Although bushings are lubricated, dirt and other debris can encroach and will significantly effect their lifetime and operation. In addition, the bushings are often plastic and the contamination, combined with the heavy loads placed upon them, wears the plastic of the bushings and reduces or eliminates the ability of the rollers to turn, essentially requiring their periodic replacement.

Steel rollers are innately very hard and not resilient. When heavy containers are rolled on these rollers, very localized stress is created on the long sills of the bodies being rolled over it. Over time, this stress can damage the long sills.

In light duty applications where multiple rollers are dispersed over an area, it has been known to employ plastics where the hardness of steel is unnecessary. Heretofore, steel rollers have uniformly been employed where tensile strength and compressive strength requirements are high.

What is needed is an improved roller having an increased lifetime, requiring less maintenance and having a more pleasing and longlasting appearance. Furthermore, a roller is desired that lessens localized stress on long sills, requires less machining and costs less to manufacture. The present invention meets each of these objectives.

### SUMMARY OF THE INVENTION

The present invention comprises a simplified roller which does not require bushings, or lubrication. The roller displays characteristics of steel relative to tensile and compressive strength but is also of lower density. It is self lubricating and incorporates a modulus of elasticity such that localized stresses caused by steel rollers is dissipated. The new roller maintains its color and general appearance longer than does a steel roller. Raw material costs as well as machining costs incurred for traditional steel rollers are reduced both in absolute values and over time.

The roller can be molded rather than machined and its raw material costs are less expensive than steel. The roller can be molded using colored material that is a uniform color all the way through and wear does not remove its color.

The roller is employed in industrial-capacity conveyor belt applications and in hook-lift trucks wherein a container slides off the truck frame for off-loading or dumping via use of the hook-lift. Specifically, the roller is molded with a first cylindrical section and a second cylindrical section of greater diameter than the first, having a single, central bore through both sections. A pin mounted on the outer surface of a truck frame is inserted through the bore and the roller is rotatably secured thereto. The long sills bearing the load rest on the first cylindrical portion while the second cylindrical section extends outside of the sills so as to guide the path of the load. Contrary to the rollers heretofore used in these applications, no bushing is employed, and no grease zerk is present or in fluid communication with the roller at any point.

The roller assembly is made by molding the roller to meet the above specifications and mounting it on a pin attached to a frame element. No outside sources for lubrication between the pin and the roller is necessary due to the self lubricating characteristic of the roller.

Other objects, features, and advantages of the present invention will be readily appreciated from the following description. The description makes reference to the accompanying drawings, which are provided for illustration of the preferred embodiment. However, such embodiment does not represent the full scope of the invention. The subject matter which the inventor does regard as his invention is particularly pointed out and distinctly claimed in the claims at the conclusion of this specification.

### BRIEF DESCRIPTION OF THE DRAWINGS

FIG. 1 is a perspective of the roller assembly of the present invention;

FIG. 2 is an end view of the roller assembly of FIG. 1;

FIG. 3 is a cross section along line 3-3 of FIG. 2 of the roller assembly of the present invention;

FIGS. 4 and 4a are perspectives of the roller of the roller assembly;

FIG. 5 is a side view of a hook lift truck with a roller assembly of the present invention installed;

FIG. 6 is a top view of a hooklift truck of FIG. 4; and

FIG. 7 is a close up perspective of the roller assembly installed on the hook lift truck of FIG. 4.

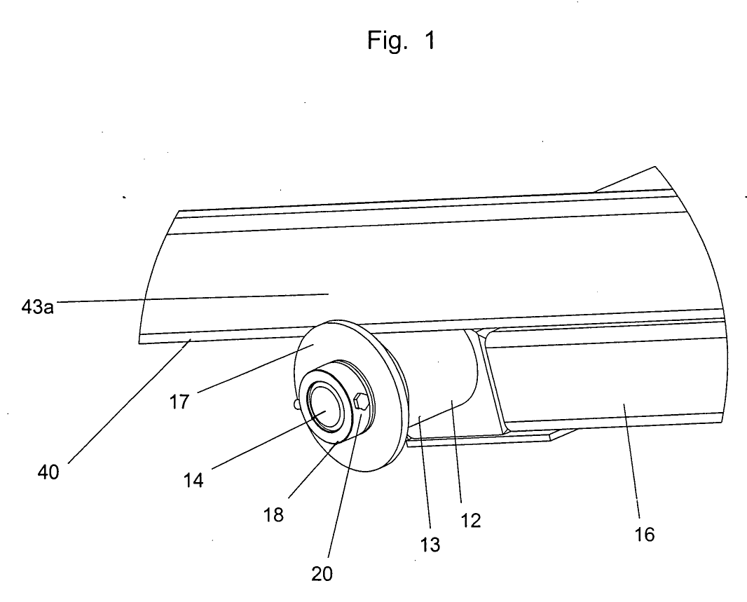

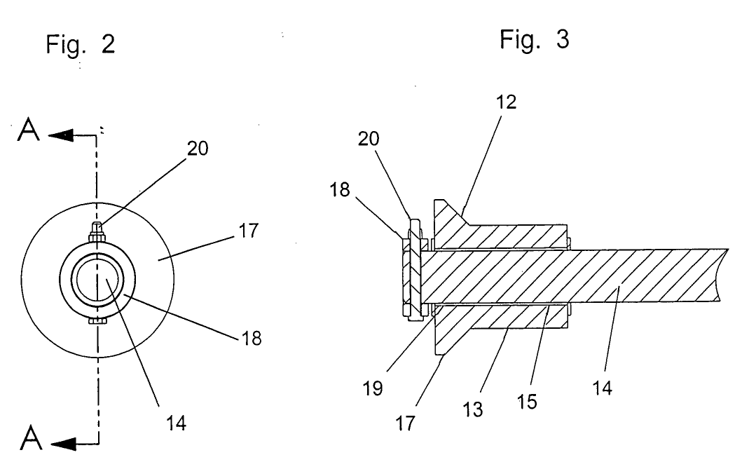

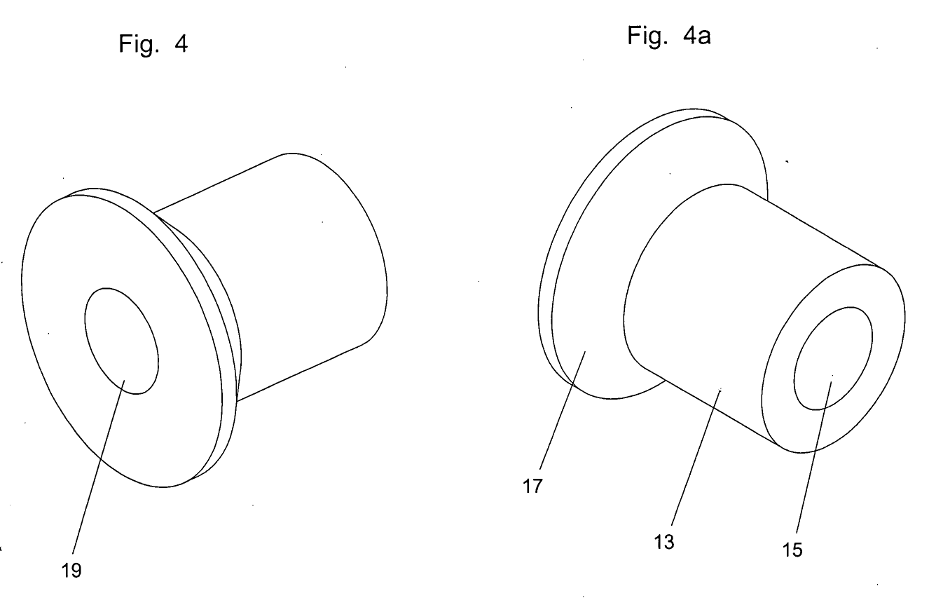

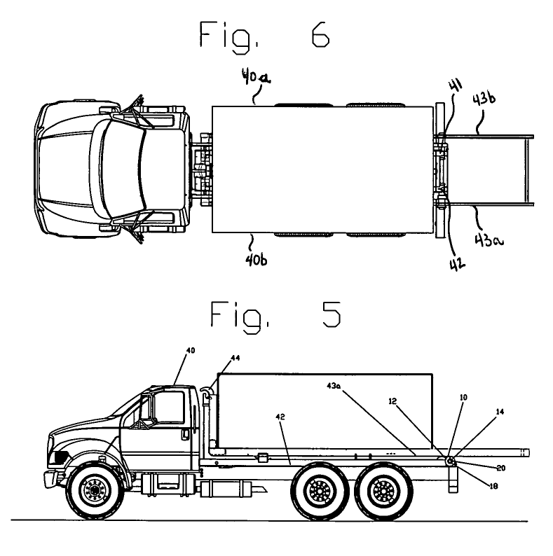

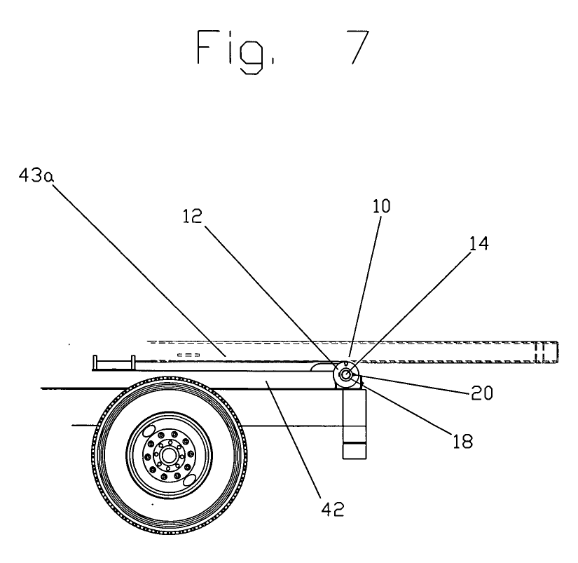

### DETAILED DESCRIPTION OF THE PREFERRED EMBODIMENT

The present invention is a roller assembly 10 comprising a roller 12 and means for rotatably mounting said roller 11. In the preferred embodiment, said roller 12 comprises a first cylindrical section 13 and a second cylindrical section 17 and a generally central bore 19 through said first section 13 and said second section 17. Means for rotably mounting said roller 11 comprises said pin 14 inserted through said bore 19, and affixed to a frame element 16, and an end piece 18. In the preferred embodiment, said end piece 18 is secured by a securing mechanism 20 such as a bolt thereby maintaining the position of the roller 12 on the pin 14 during rotation.

Said roller 12 comprises a generally uniform, self-lubricating material having compressive strength of about 8000 psi and preferably more, tensile strength of about 12000 psi and preferably more, modular elasticity of about 400 ksi and preferably more, and thermal operating range of between about −30 F and about 200 F. The tradename of a material meeting these specifications is MC® 907, however, it should be noted that other materials meeting the specifications herein can successfully be employed.

Means for rotational lubrication 30 of the roller relative to the pin 14 comprise self-lubrication inherent in the roller's material make up. In the preferred embodiment, no additional lubrication is contemplated nor are ports provided therefore. The roller assembly 10 may be used in a variety of industrial applications requiring transport of heavy materials. One such application would be in conjunction with a hooklift truck 40 comprising a first side 40a, a second side 40b, a first fame element 41, a second frame element 42, a hooklift 44, a load 46 supported by a pair of long sills 43a, 43b and at least one pair of roller assemblies 10a, 10b. The load 46 is supported by the long sills 43a, 43b one of which rests on the first cylindrical section 13 of said first assembly and the second of said pair rests on said second assembly. When the hooklift 44 is actuated, the rollers 12 on each of said pair of assemblyies 10a, 10b rotate via means for rotatably mounting said roller 11 as the sills 43a and 43b move over them and the load 46 is off-loaded. The second cylindrical section 17 of each roller 12 acts as a guide for one of the long sills 43a or 43b by extending upward past the lower edge 48 of each sill 43a, 43b. Rollers 12 serve the same purpose when a load 46 is on-loaded.

Preferably, the roller assembly 10 is made by molding a plastic meeting the stated characteristics into a roller having a central bore, and then inserting and securing the pin 14 therein. Due to the self-lubricating characteristic of the plastic, no additional lubrication ports or mechanisms are necessary.

Thus, the present invention has been described in an illustrative manner. It is to be understood that the terminology that has been used is intended to be in the nature of words of description rather than of limitation.

Many modifications and variations of the present invention are possible in light of the above teachings. For example, a variety of plasicis might meet the requirements of this invention and the roller's geometry may vary. Therefore, within the scope of the appended claims, the present invention may be practiced otherwise than as specifically described.

What I claim is:

1. A roller assembly used to assist in the conveyance of heavy loads comprising:
a) a roller comprising a first cylindrical section, a second cylindrical section, a single generally central bore through said first and second sections, and a generally uniform construction consisting essentially of a self-lubricating nonmetallic material having a compressive strength of at least about 8000 psi and a modular of elasticity of about 400 ksi; and
b) means for rotatably mounting said roller.

2. The roller assembly of claim 1 wherein said means for rotatably mounting said roller comprises a pin inserted through said bore and first and second sections and affixed to a frame element and a securing mechanism.

3. The roller assembly of claim 2 wherein said means for rotatably mounting said roller further comprises an end piece.

4. The roller assembly of claim 1 wherein said second cylindrical section comprises a diameter larger than that of said first cylindrical section.

5. A roller assembly used to assist in the conveyance of heavy loads comprising a non-metallic roller having a single bore, no port for addition of lubrication, and compressive strength of about 8000 psi; a pin; and a securing mechanism wherein said pin is attached to a frame element and secured in said bore by said securing mechanism allowing said roller to rotate about said pin.

6. The roller assembly as claimed in claim 4 wherein said roller further comprises a first cylindrical section and a second cylindrical section; said bore pierces said first and second sections sequentially and coaxially, a modular of elasticity of about 400 ksi, and means for rotational lubrication consisting essentially of a self-lubricating characteristic of the nonmetallic roller.

7. The process of making a heavy duty roller assembly comprising molding a roller of nonmetallic material having a tensile strength of about 12000 psi, a modular of elasticity of about 400 ksi, and a compressive strength of about 8000 psi.

8. The process as claimed in claim 7 further comprising molding the roller with a first bore into which means for rotatably mounting said roller may be inserted.

9. The process as claimed in claim 8 wherein said nonmetallic material further comprises a self-lubricating characteristic and said roller assembly includes no grease zerk and no bushing.

10. A method of using the roller assembly of claim 8 wherein said means for rotatably mounting said roller comprises a pin, said pin is affixed at a first end to a frame element, the pin is inserted into said bore of said roller and affixed to a frame element at one end and secured in said roller by a securing mechanism at the other end.

11. The method of claim 10 wherein said securing mechanism comprises a nut and bolt assembly perpendicular to and inserted through a bore in said pin.

12. A roller assembly comprising:
a) a nonmetallic roller having tensile strength of at least about 12000 psi;
b) means for rotatably mounting said roller; and
c) no bushing.

13. The roller assembly of claim 12 wherein said means for rotatably mounting said roller comprises a pin mounted on a frame element and said assembly further comprises an end piece and a securing mechanism for holding said roller in position relative to said frame element.

14. The roller assembly of claim 13 wherein said nonmetallic roller further comprises a compressive strength of at least about 8000 psi and a modular elasticity of at least about 400 ksi.

15. The roller assembly of claim 13 wherein said roller has no grease zerk.

16. The roller assembly of claim 13 wherein said assembly has no grease zerk.

17. A method of using at least one pair of roller assemblies of claim 13 wherein said frame element is attached to a first side of a hooklift truck and one of said pair of roller assemblies; a second frame element is attached to a second side of said hooklift truck and the second of said pair of roller assemblies; said hooklift truck comprises a hooklift and a pair of long sills is used to support a load; each of said pair of long sills is positioned to rest on one of said pair of roller assemblies; said hooklift is activated and said pair of long sills moves over and rotates each of said pair of rollers in each of said pair of assemblies as said load is moved relative to said hooklift truck thereby facilitating the movement of said load.

18. A roller assembly comprising:
a) a nonmetallic roller comprising less than two bores, a first cylindrical section coaxial with a second cylindrical section wherein said less than two bores pierces coaxially each of said sections;
b) means to rotatably mount said roller;
c) said roller comprising a tensile strength of about 12000 psi, modular elasticity of about 400 ksi and compressive strength of about 8000 psi;
d) an end piece and a securing mechanism for maintaining the position of the roller relative to said means to rotatably mount said roller.
